(19) United States
(12) Patent Application Publication
(10) Pub. No.: US 2022/0045348 A1
(43) Pub. Date: Feb. 10, 2022

(54) ELECTROCHEMICAL CELL AND HYDROGEN GENERATION METHOD

(71) Applicant: Panasonic Intellectual Property Management Co., Ltd., Osaka (JP)

(72) Inventors: TAKEHITO GOTO, Osaka (JP); TOMOHIRO KUROHA, Osaka (JP); TAKASHI KAKUWA, Osaka (JP); TAKESHI TERAYAMA, Osaka (JP); SHIGENORI ONUMA, Kyoto (JP); YUICHI MIKAMI, Kyoto (JP); KOSUKE NUNOO, Osaka (JP); KYOHEI KAWADA, Osaka (JP)

(21) Appl. No.: 17/505,695

(22) Filed: Oct. 20, 2021

Related U.S. Application Data
(63) Continuation of application No. PCT/JP2020/018754, filed on May 11, 2020.

(30) Foreign Application Priority Data
May 27, 2019 (JP) 2019-098695

(51) Int. Cl. H01M 8/1253; C01B 3/26; C25B 1/044; H01M 4/90

(52) U.S. Cl. CPC H01M 8/1253; C01B 3/26; H01M 2008/1293; H01M 4/9033; C25B 1/044

(57) ABSTRACT

An electrochemical cell of the present disclosure includes a first cell and a second cell. The first cell includes a first electrolyte layer containing an oxide ion conductor. The second cell includes a second electrolyte layer containing a proton conductor, and the second cell is disposed to face the first cell.

### BACKGROUND

### 1. Technical Field

The present disclosure relates to an electrochemical cell and a hydrogen generation method.

### 2. Description of the Related Art

As a method for producing hydrogen by using electrolysis, high-temperature water vapor electrolysis that uses a solid oxide electrolysis cell (SOEC) is known. In high-temperature water vapor electrolysis, thermal energy is used as energy necessary for the electrolysis reaction, and, accordingly, a high conversion efficiency can be achieved. As an electrolyte for the solid oxide electrolysis cell, an oxide ion conductor, such as yttria-stabilized zirconia, is used.

In high-temperature water vapor electrolysis, water vapor is supplied to a hydrogen electrode, and the water vapor is decomposed into hydrogen and oxide ions. The oxide ions migrate through the electrolyte layer to reach an oxygen electrode, and the oxide ions become oxygen at the oxygen electrode. A gas mixture of the generated hydrogen and the residual water vapor is discharged from the hydrogen electrode.

From the standpoint of use of the hydrogen, it is desirable that the purity of the generated hydrogen be increased. Japanese Unexamined Patent Application Publication No. 2010-176939 describes an electrical power storage system configured such that the gas mixture of hydrogen and water vapor is passed through a condenser to remove water, and subsequently, the hydrogen is compressed and stored in a hydrogen storage tank.

### SUMMARY

In the system described in Japanese Unexamined Patent Application Publication No. 2010-176939, an electrochemical cell and the condenser are completely separated and connected to each other with a conduit. Such a configuration renders miniaturization of a system difficult.

One non-limiting and exemplary embodiment provides a technology for facilitating miniaturization of a system.

In one general aspect, the techniques disclosed here feature an electrochemical cell. The electrochemical cell includes a first cell including a first electrolyte layer containing an oxide ion conductor; and a second cell including a second electrolyte layer containing a proton conductor, the second cell being disposed to face the first cell.

An electrochemical cell of the present disclosure facilitates miniaturization of systems that use the electrochemical cell.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a perspective view of an electrochemical cell according to a first embodiment of the present disclosure;

FIG. 1B is a cross-sectional view of the electrochemical cell according to the first embodiment of the present disclosure;

FIG. 2 is a cross-sectional view of an electrochemical cell according to a second embodiment of the present disclosure;

FIG. 3 is a cross-sectional view of an electrochemical cell according to a third embodiment of the present disclosure;

FIG. 4A is a perspective view of an electrochemical cell according to a fourth embodiment of the present disclosure;

FIG. 4B is a cross-sectional view of the electrochemical cell according to the fourth embodiment of the present disclosure;

FIG. 5 is a cross-sectional view of an electrochemical cell according to a fifth embodiment of the present disclosure;

FIG. 6 is a cross-sectional view of an electrochemical cell according to a sixth embodiment of the present disclosure; and

FIG. 7 is a cross-sectional view of an electrochemical cell according to a seventh embodiment of the present disclosure.

### DETAILED DESCRIPTION

### Underlying Knowledge Forming Basis of the Present Disclosure

The present inventors diligently performed studies regarding technologies for separating hydrogen from the gas mixture. As a result, the present inventors discovered that highly concentrated hydrogen can be obtained by using a proton conductor. It was discovered that combining the hydrogen separation that uses a proton conductor with an SOEC enables highly concentrated hydrogen to be generated without relying on a condenser.

### Overview of Aspects of the Present Disclosure

According to a first aspect of the present disclosure, an electrochemical cell includes

a first cell including a first electrolyte layer containing an oxide ion conductor; and

a second cell including a second electrolyte layer containing a proton conductor, the second cell being disposed to face the first cell.

The electrochemical cell of the first aspect facilitates miniaturization of systems that use the electrochemical cell.

In a second aspect of the present disclosure, the electrochemical cell according to the first aspect may, for example, further include a gas path provided between the first cell and the second cell, and the first cell and the second cell may face each other across the gas path. This configuration enables hydrogen generated in the first cell to be easily directed to the second cell.

In a third aspect of the present disclosure, the electrochemical cell according to the second aspect may be such that, for example, a downstream end of the gas path is closed. This configuration maximizes water vapor utilization efficiency.

In a fourth aspect of the present disclosure, the electrochemical cell according to the second or third aspect may, for example, further include a porous layer disposed between the first cell and the second cell, and at least a part of the gas path may be composed of the porous layer. This configuration allows the water vapor and hydrogen necessary for the reactions to circulate through the gas path between the first cell and the second cell while providing a connection between the first cell and the second cell.

In a fifth aspect of the present disclosure, the electrochemical cell according to the second or third aspect may, for example, further include a support that is disposed in the gas path and the support is in contact with the first cell and the second cell. This configuration allows the water vapor and hydrogen necessary for the reactions to circulate through the gas path between the first cell and the second cell while providing a connection between the first cell and the second cell,

In a sixth aspect of the present disclosure, the electrochemical cell according to any one of the second to fifth aspects may be such that, for example, a flow path cross-sectional area of an upstream part of the gas path is larger than a flow path cross-sectional area of a downstream part of the gas path. This configuration facilitates one-direction flow of the water vapor used in the reaction, from an upstream side toward a downstream side.

In a seventh aspect of the present disclosure, the electrochemical cell according to any one of the first to sixth aspects may be such that, for example, the first cell further includes a first electrode and a second electrode; in the first cell, the first electrolyte layer is disposed between the first electrode and the second electrode; the second cell further includes a third electrode and a fourth electrode; in the second cell, the second electrolyte layer is disposed between the third electrode and the fourth electrode; and the first electrode and the third electrode face each other. This configuration enables the water vapor present in the gas path to be rapidly processed in the first electrode and enables the hydrogen present in the gas path to be rapidly processed in the third electrode.

In an eighth aspect of the present disclosure, the electrochemical cell according to the seventh aspect may be such that, for example, hydrogen is generated at the first electrode, hydrogen is generated at the second electrode, hydrogen is converted to protons at the third electrode, and hydrogen is generated at the fourth electrode. This configuration enables the production of highly concentrated hydrogen.

In a ninth aspect of the present disclosure, the electrochemical cell according to any one of the first to eighth aspects may, for example, further include a power source that supplies power to the first cell and the second cell. This configuration enables reliable supply of necessary electrical energy to the first cell and the second cell, thereby enabling efficient generation of highly concentrated hydrogen.

In a tenth aspect of the present disclosure, the electrochemical cell according to any one of the first to eighth aspects may, for example, further include a first power source that supplies power to the first cell; and a second power source that supplies power to the second cell. This configuration enables separate supply of power to the first cell and the second cell, with each of the supplies being in a suitable amount for high-output operation.

In an eleventh aspect of the present disclosure, the electrochemical cell according to any one of the first to tenth aspects may be such that, for example, the proton conductor includes at least one selected from the group consisting of BaZr₁₋ₓ₁M1ₓ₁O_{3-δ}, BaCe₁₋ₓ₂M2ₓ₂O_{3-δ}, and BaZr_{1-x3-y3}Ceₓ₃M3_{y3}O_{3-δ}. M1, M2, and M3 may each include at least one selected from the group consisting of Pr, Nd, Pm, Sm, Eu, Gd, Tb, Dy, Ho, Er, Tm, Yb, Y, Sc, In, and Lu; a value of x1 satisfies 0<x1<1; a value of x2 satisfies 0<x2<1; a value of x3 satisfies 0<x3 <1; a value of y3 satisfies 0<y3<1; and a value of δ satisfies 0<δ<0.5. These proton conductors have high proton conductivity at an operating temperature of the electrochemical cell,

In a twelfth aspect of the present disclosure, the electrochemical cell according to the eleventh aspect may be such that, for example, the proton conductor is made of BaZr₁₋ₓ₁M1ₓ₁O_{3-δ}. BaZr₁₋ₓ₁Ybₓ₁O_{3-δ} has high proton conductivity.

In a thirteenth aspect of the present disclosure, the electrochemical cell according to the seventh aspect may be such that, for example, hydrogen is converted to protons at the fourth electrode, hydrogen is generated at the third electrode, and the first cell generates power by using hydrogen supplied to the first electrode and oxygen supplied to the second electrode. This configuration enables the supply of electrical energy to the outside.

According to a fourteenth aspect of the present disclosure, a hydrogen generation method includes

disposing a first cell and a second cell so as to face each other, the first cell including an oxide ion conductor as an electrolyte, the second cell including a proton conductor as an electrolyte;

generating hydrogen and oxygen by decomposing water vapor by using the first cell; and

separating the hydrogen from a mixture gas of the hydrogen generated in the first cell and water vapor which has not been decomposed in the first cell.

The fourteenth aspect enables efficient generation of highly concentrated hydrogen.

Embodiments of the present disclosure will now be described with reference to the drawings. The present disclosure is not limited to the embodiments described below.

### First Embodiment

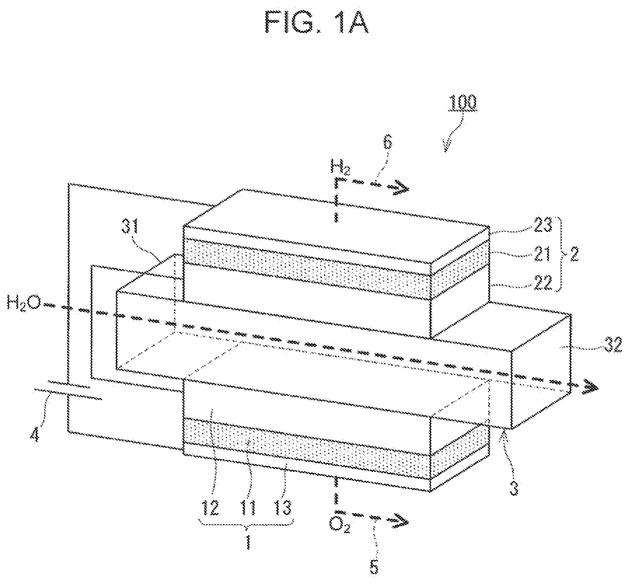

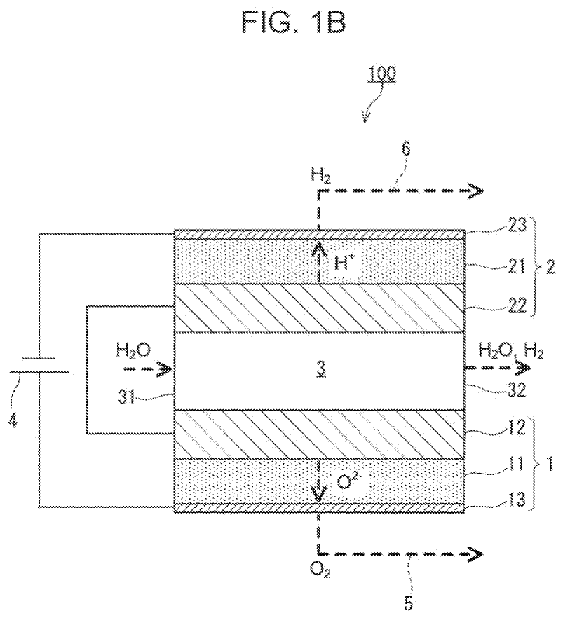

FIG. 1A illustrates, in perspective view, a configuration of an electrochemical cell 100, according to a first embodiment of the present disclosure. FIG. 1B illustrates a cross section of the electrochemical cell 100 illustrated in FIG. 1A. The electrochemical cell 100 includes a first cell 1 and a second cell 2. The second cell 2 is disposed to face the first cell 1.

The first cell 1 is formed of a first electrolyte layer 11, a first electrode 12, and a second electrode 13. The first electrolyte layer 11 is disposed between the first electrode 12 and the second electrode 13. The first electrolyte layer 11 includes an oxide ion conductor that serves as an electrolyte.

The second cell 2 is formed of a second electrolyte layer 21, a third electrode 22, and a fourth electrode 23. The second electrolyte layer 21 is disposed between the third electrode 22 and the fourth electrode 23. The second electrolyte layer 21 includes a proton conductor that serves as an electrolyte.

In the present embodiment, the first cell 1 and the second cell 2 both have a plate shape and are arranged to be parallel to each other with a predetermined space therebetween.

In the electrochemical cell 100, the first cell 1 plays a role different from the role of the second cell 2. The first cell 1 generates hydrogen and oxygen by decomposing water vapor. This process is high-temperature water vapor electrolysis that uses an SOEC. The second cell 2 selectively separates the hydrogen from a gas mixture of the hydrogen generated in the first cell 1 and the water vapor which has not been decomposed in the first cell 1, by using the function of the proton conductor. Accordingly, highly concentrated hydrogen can be produced. Since the first cell 1 and the second cell 2 face each other, the hydrogen generated in the first cell 1 easily reaches the second cell 2 and is immediately processed by the second cell 2.

The electrochemical cell 100 of the present embodiment enables the generation of highly concentrated hydrogen without requiring the use of a condenser for removing water vapor from the gas mixture. That is, the electrochemical cell 100 facilitates miniaturization of a hydrogen generation system. Of course, the electrochemical cell 100 can be used in combination with a condenser. In this case, miniaturization of the system can be expected to be achieved by reducing a size of the condenser.

In this specification, the terms “hydrogen” and “oxygen” refer to “hydrogen gas” and “oxygen gas”, respectively, unless otherwise specified.

Regarding the first cell 1, examples of the oxide ion conductor that is used in the first electrolyte layer 11 include stabilized zirconia, lanthanum gallate-based oxides, and cerin-based oxides. Typically, the first electrolyte layer 11 is formed of yttria-stabilized zirconia (YSZ).

The first electrode 12 includes a catalyst for promoting an electrochemical oxidation reaction of the water vapor. The catalyst may be a metal, such as Ni. The first electrode 12 may be made of a cermet. The cermet is a mixture of a metal and a ceramic material. Examples of the cermet include Ni—YSZ and a mixture of Ni and a cerin-based oxide. In instances where the first electrode 12 is formed of a cermet, an expected effect is an increase in the reactive active sites for oxidizing water vapor. The first electrode 12 may be a porous body so as to facilitate the diffusion of water vapor.

The second electrode 13 includes a catalyst for promoting an electrochemical oxidation reaction of oxide ions. The catalyst may be an oxide containing at least one selected from the group consisting of Mn, Fe, Co, and Ni. Specific examples of the catalyst include lanthanum strontium cobalt iron complex oxide (LSCF), lanthanum strontium cobalt complex oxide (LSC), lanthanum strontium iron complex oxide (LSF), lanthanum strontium manganese complex oxide (LSM), barium strontium cobalt iron complex oxide (BSCF), samarium strontium cobalt complex oxide (SSC), lanthanum nickel iron complex oxide, lanthanum nickel complex oxide, and barium gadolinium lanthanum cobalt complex oxide, The catalyst may be a composite of a first oxide and a second oxide or a composite of the first oxide and a metal. The first oxide contains at least one selected from the group consisting of Mn, Fe, Co, and Ni. The second electrode 13 may be a porous body so as to facilitate the diffusion of the generated oxygen.

Regarding the second cell 2, examples of the proton conductor that is used in the second electrolyte layer 21 include proton-conducting oxides. Specifically, the proton conductor that is included in the second electrolyte layer 21 may be at least one selected from the group consisting of BaZr₁₋ₓ₁M1ₓ₁O_{3-δ}, BaCe₁₋ₓ₂M2ₓ₂O_{3-δ}, and BaZr_{1-x3-y3}Ceₓ₃M3_{y3}O_{3-δ}. M1, M2, and M3 may each include at least one selected from the group consisting of Pr, Nd, Pm, Sm, Eu, Gd, Tb, Dy, Ho, Er, Tm, Yb, Y, Sc, In, and Lu. x1 satisfies 0<x1<1. x2 satisfies 0<x2<1. x3 satisfies 0<x3<1. y3 satisfies 0<y3<1. The value of δ satisfies 0<δ<0.5. These proton conductors have high proton conductivity. Using a solid electrolyte having high proton conductivity improves the electrochemical performance of the second cell 2. The proton conductor may be made of BaZr₁₋ₓ₁Ybₓ₁O_{3-δ}. BaZr₁₋ₓ₂Ybₓ₁O_{3-δ} has high proton conductivity. The variable δ is a value by which an amount of oxygen deficiency in the crystal lattice of the oxide is indicated on the composition. The value of δ varies depending on the value of x1, the value of x2, the value of x3, the value of y3, a temperature, an oxygen partial pressure, a water vapor partial pressure, and the like. The second electrolyte layer 21 may be a dense body.

The third electrode 22 includes a catalyst for electrochemically oxidizing hydrogen. The catalyst may be a metal, such as Ni. The third electrode 22 may be formed of a cermet. The cermet may be a mixture of Ni and a proton-conducting oxide, and examples of the mixture include a mixture of Ni and BaZ₁₋ₓ₁Ybₓ₁O_{3-δ}. In instances where the third electrode 22 is formed of a cermet, an expected effect is an increase in the reactive active sites for oxidizing hydrogen. The third electrode 22 may be a porous body so as to facilitate the diffusion of hydrogen and water vapor.

The fourth electrode 23 includes a catalyst for electrochemically reducing protons. The catalyst may be a metal, such as Ni. The fourth electrode 23 may be formed of a cermet. The cermet may be a mixture of Ni and a proton-conducting oxide, and examples of the mixture include a mixture of Ni and BaZr₁₋ₓ₁Ybₓ₁O_{3-δ}. In instances where the fourth electrode 23 is formed of a cermet, an expected effect is an increase in the reactive active sites for reducing protons. The fourth electrode 23 may be a porous body so as to facilitate the diffusion of hydrogen.

The “porous body” or a “porous material” refers to a material having a porosity of greater than or equal to 20%, for example. The porosity can be measured by using an Archimedes method or a mercury intrusion porosimetry method.

The electrochemical cell 100 further includes a gas path 3. The gas path 3 is provided between the first cell 1 and the second cell 2. The first cell 1 and the second cell 2 face each other across the gas path 3, This configuration enables the hydrogen generated in the first cell 1 to be easily directed to the second cell 2. The water vapor electrolysis in the first cell 1 and the hydrogen separation in the second cell 2 proceed smoothly.

The first cell 1 and the second cell 2 face the gas path 3. Specifically, the first electrode 12 of the first cell 1 and the third electrode 22 of the second cell 2 face the gas path 3. The first electrode 12 and the third electrode 22 face each other. In other words, at least a part of an inner wall surface of the gas path 3 is composed of the first electrode 12 and the third electrode 22. This configuration enables the water vapor present in the gas path 3 to be rapidly processed in the first electrode 12 and enables the hydrogen present n the gas path 3 to be rapidly processed in the third electrode 22.

The gas path 3 may be a space between the first cell 1 and the second cell 2. For example, in an instance where the first cell 1 and the second cell 2 have a cylindrical shape and are disposed concentrically, the space between the first cell 1 and the second cell 2 composes the gas path 3. Alternatively, a different member, other than the first cell 1 or the second cell 2, may constitute the gas path 3. The different member may be a metal conduit. The first cell 1 and the second cell 2 may be mounted to the metal conduit such that the first cell 1 and the second cell 2 face an inner part of the metal conduit.

The gas path 3 includes an inlet 31 and an outlet 32. Water vapor, which is the raw material for the water vapor electrolysis, is fed to the electrochemical cell 100 through the inlet 31. Unreacted hydrogen and unreacted water vapor are discharged from the electrochemical cell 100 through the outlet 32.

Note that the electrochemical cell 100 may include a connection structure so that the gas path 3 can be ensured, that is, a configuration in which the first cell 1 is separated from the second cell 2 can be provided. For example, the connection structure is provided at each of four corners of the first cell 1 and the second cell 2. The connection structure holds the first cell 1 and the second cell 2 in a manner such that the first electrode 12 of the first cell 1 is separated from the third electrode 22 of the second cell 2.

The electrochemical cell 100 further includes an oxygen passage 5 and a hydrogen passage 6. The oxygen passage 5 is a passage through which oxygen generated in the first cell 1 flows. The oxygen passage 5 is connected to the first cell 1. Specifically, the oxygen passage 5 is connected to the second electrode 13 of the first cell 1. A terminal end of the oxygen passage 5 is connected to, for example, oxygen storage equipment. The hydrogen passage 6 is a passage through which hydrogen separated in the second cell 2 flows. The hydrogen passage 6 is connected to the second cell 2. Specifically, the hydrogen passage 6 is connected to the fourth electrode 23 of the second cell 2. A terminal end of the hydrogen passage 6 is connected to, for example, hydrogen storage equipment. The oxygen passage 5 and the hydrogen passage 6 may be composed of a heat-resistant conduit, which may be, for example, a metal conduit.

The electrochemical cell 100 further includes a power source 4. The power source 4 supplies power to the first cell 1 and the second cell 2. In the present embodiment, the power source 4 is shared by the first cell 1 and the second cell 2. The power source 4 is connected to the second electrode 13 of the first cell 1 and to the fourth electrode 23 of the second cell 2. The first electrode 12 of the first cell 1 is electrically connected to the third electrode 22 of the second cell 2. That is, the first cell 1 is connected to the second cell 2 in series. The power source 4 enables reliable supply of necessary electrical energy to the first cell 1 and the second cell 2, thereby enabling efficient generation of highly concentrated hydrogen. The shared use of the power source 4 by the first cell 1 and the second cell 2 contributes to a cost reduction.

Now, operation of the electrochemical cell 100 will be described in detail. In the electrochemical cell 100, a step of generating hydrogen and oxygen by electrolyzing water vapor and a step of separating hydrogen from a gas mixture of hydrogen and water vapor proceed in parallel. The step of generating hydrogen and oxygen is carried out by using the first cell 1, which includes an oxide ion conductor that serves as an electrolyte. The step of separating hydrogen from a gas mixture is carried out by using the second cell 2, which includes a proton conductor that serves as an electrolyte. The gas mixture contains the hydrogen generated in the first cell 1 and the water vapor which has not been decomposed in the first cell 1. Implementation of these steps enables efficient generation of highly concentrated hydrogen.

First, the power source 4 is turned on to supply water vapor to the gas path 3. When the water vapor reaches a surface of the first cell 1, the water vapor is reduced to hydrogen and oxide ions at the first electrode 12. Specifically, the water vapor is reduced to hydrogen and oxide ions at or near an interface between the first electrolyte layer 11 and the first electrode 12. The oxide ions migrate through the first electrolyte layer 11 to reach the second electrode 13. At the second electrode 13, an oxidation reaction of the oxide ions occurs, which generates oxygen. Specifically, the oxide ions are oxidized and converted to oxygen at or near an interface between the first electrolyte layer 11 and the second electrode 13. The oxygen is discharged from the second electrode 13 and directed to the outside of the electrochemical cell 100 through the oxygen passage 5.

The hydrogen generated at the surface of the first cell 1 diffuses through the gas path 3 to reach a surface of the second cell 2. When the hydrogen reaches the surface of the second cell 2, the hydrogen is oxidized and converted to protons at the third electrode 22. Specifically, the hydrogen is oxidized and converted to protons at or near an interface between the second electrolyte layer 21 and the third electrode 22. The protons migrate through the second electrolyte layer 21 to reach the fourth electrode 23. At the fourth electrode 23, a reduction reaction of the protons occurs, which generates hydrogen. Specifically, the protons are reduced and converted to hydrogen at or near an interface between the second electrolyte layer 21 and the fourth electrode 23. The hydrogen is directed to the outside of the electrochemical cell 100 through the hydrogen passage 6. Based on the reactions described above, only the hydrogen generated by the reaction at or near the interface between the second electrolyte layer 21 and the fourth electrode 23 is supplied to the outside of the electrochemical cell 100. Accordingly, highly concentrated hydrogen can be obtained.

A gas mixture of unreacted hydrogen and unreacted water vapor is discharged to the outside of the electrochemical cell 100 through the gas path 3.

The reaction at each of the electrodes is as follows.

First electrode 12: 2H₂O+4e⁻→2H₂+2O²⁻

Second electrode 13: 2O²⁻→O₂+4e⁻

Third electrode 22: H₂→2H⁺+2e⁻

Fourth electrode 23: 2H⁺2e⁻→H₂

During the operation of the electrochemical cell 100, an ambient temperature (i.e., an operating temperature) of the first cell 1 and the second cell 2 is maintained at greater than or equal to 500° C. and less than or equal to 1000° C., for example. The operating temperature is specified based on an oxide ion conductivity of the oxide ion conductor included in the first electrolyte layer 11. For example, in an instance where yttria-stabilized zirconia is used in the first electrolyte layer 11, the operating temperature may be set to be greater than or equal to 700° C. The temperature at which the second electrolyte layer 21 exhibits sufficient proton conductivity is approximately 600° C., which is less than the temperature suitable for the first electrolyte layer 11. The first cell 1 and the second cell 2 may be stored in a thermally insulating housing.

Some additional embodiments will be described below. Elements of an embodiment that are common with those of the first embodiment are designated with the same reference numerals, and descriptions thereof may be omitted. Regarding the embodiments disclosed herein, the description of one embodiment may apply to another embodiment as long as there is no technical inconsistency. Any combination of the embodiments is possible as long as there is no technical inconsistency.

### Second Embodiment

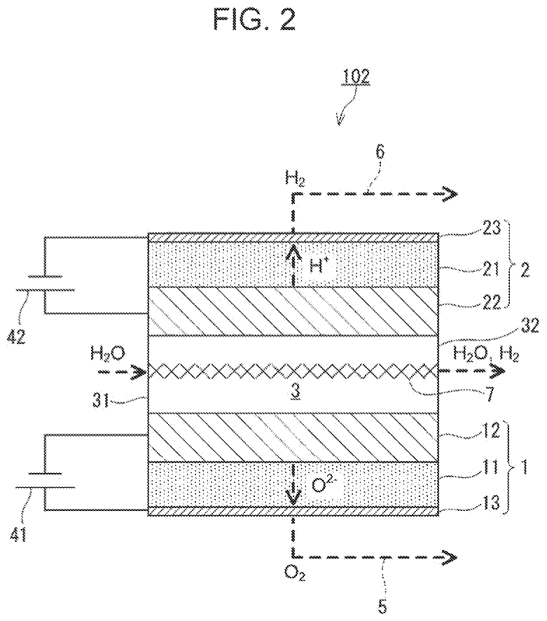

FIG. 2 illustrates a cross section of an electrochemical cell 102, according to a second embodiment of the present disclosure. The electrochemical cell 102 includes a first power source 41 and a second power source 42, instead of the power source 4. The first power source 41 supplies power to a first cell 1. The first power source 41 is connected to a first electrode 12 of the first cell 1 and to a second electrode 13 of the first cell 1. The second power source 42 supplies power to a second cell 2. The second power source 42 is connected to a third electrode 22 of the second cell 2 and to a fourth electrode 23 of the second cell 2.

In the instance of the power source 4, which has been described earlier, since the first cell 1 and the second cell 2 are connected to each other in series, currents with the same value flow through the first cell 1 and the second cell 2. However, the current value suitable for the water vapor electrolysis reaction in the first cell 1 may be different from the current value suitable for the electrochemical hydrogen separation in the second cell 2. The present embodiment enables separate control of the first power source 41 and the second power source 42. In this instance, an amount of power suitable for the first cell 1 and an amount of power suitable for the second cell 2 can be supplied, and, therefore, the electrochemical cell 102 has excellent control.

In the present embodiment, the first cell 1 and the second cell 2 are electrically insulated from each other. The electrochemical cell 102 may further include an insulator layer 7 so that the first cell 1 and the second cell 2 can be reliably isolated from each other. The insulator layer 7 may be disposed between the first cell 1 and the second cell 2. The insulator layer 7 can be disposed in the gas path 3 such that, for example, the insulator layer 7 divides the gas path 3 along a gas flow direction. Example of a material of the insulator layer 7 include oxides, such as alumina, stabilized zirconia, and barium zirconate-based oxides. Another material that can be used as a material of the insulator layer 7 is a glass-based seal material.

### Third Embodiment

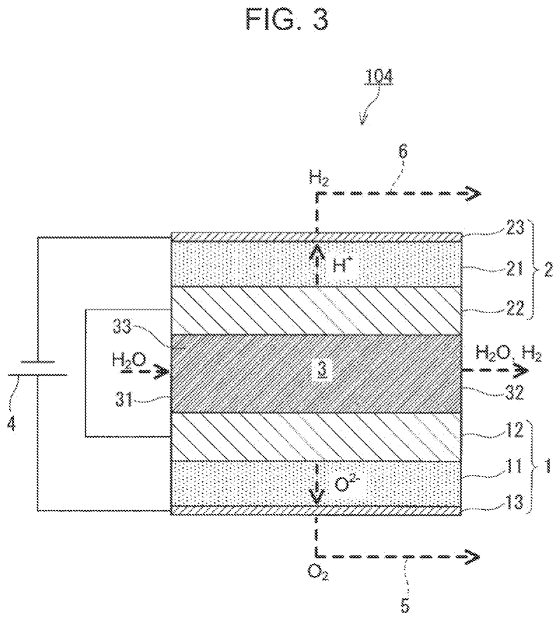

FIG. 3 illustrates a cross section of an electrochemical cell 104, according to a third embodiment of the present disclosure. The electrochemical cell 104 additionally includes a porous layer 33, which is disposed between a first cell 1 and a second cell 2. At least a part of a gas path 3 is composed of the porous layer 33. The porous layer 33 connects the first cell 1 to the second cell 2. The first cell 1 and the second cell 2 are secured to each other by the porous layer 33.

The porous layer 33 allows the water vapor and hydrogen necessary for the reactions to circulate through the gas path 3 between the first cell 1 and the second cell 2 while providing a connection between the first cell 1 and the second cell 2. The electrochemical cell 104, as a whole, efficiently contributes to the reactions while allowing the circulation of the water vapor supplied from the outside and the hydrogen generated at the first electrode 12.

Examples of a porous material that forms the porous layer 33 include porous ceramics, porous metal bodies, and metal meshes. For example, the porous layer 33 has a porosity of greater than or equal to 20%. Note that in an instance where the porous layer 33 is made of a metal, insulation may be provided to prevent shorting between the first electrode 12 and the third electrode 22 from occurring via the porous layer 33.

### Fourth Embodiment

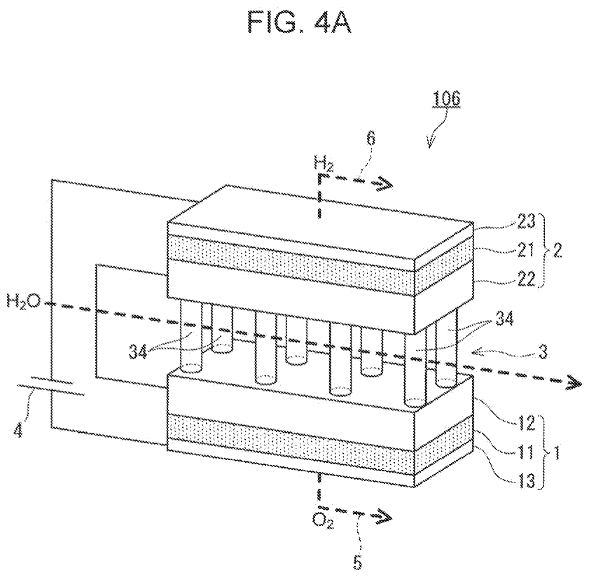

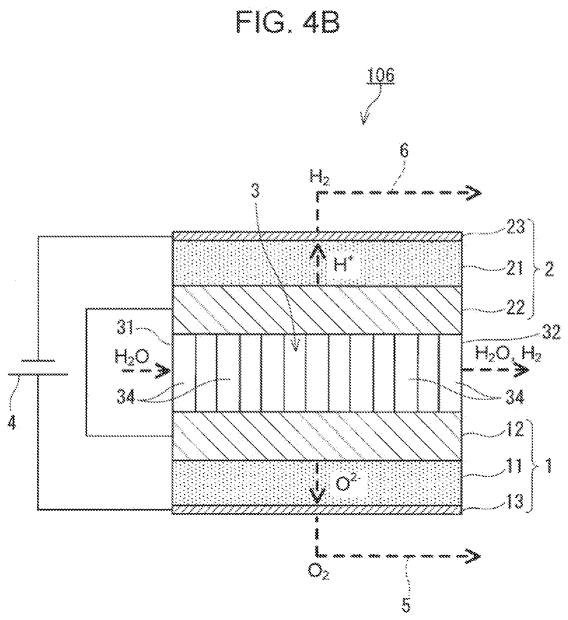

FIG. 4A illustrates, in perspective view, a configuration of an electrochemical cell 106, according to a fourth embodiment of the present disclosure. FIG. 4B illustrates a cross section of the electrochemical cell 106 illustrated in FIG. 4A. The electrochemical cell 106 additionally includes at least one support 34, which is disposed in the gas path 3. In the present embodiment, a plurality of supports 34 are provided. The supports 34 connect a first cell 1 to a second cell 2. The supports 34 secure the first cell 1 and the second cell 2 to each other.

The supports 34 allow the water vapor and hydrogen necessary for the reactions to circulate through the gas path 3 between the first cell 1 and the second cell 2 while providing a connection between the first cell 1 and the second cell 2. The electrochemical cell 106, as a whole, efficiently contributes to the reactions while allowing the circulation of the water vapor supplied from the outside and the hydrogen generated at the first electrode 12.

In the present embodiment, the supports 34 are regularly arranged. The supports 34 are spaced at equal intervals in a water vapor flow direction. However, the arrangement of the supports 34 is not particularly limited provided that the first cell 1 and the second cell 2 are stably secured to each other. The factors that determine the arrangement of the supports 34 include the number of the supports 34 and positions of the supports 34. For example, when both the first cell 1 and the second cell 2 have a rectangular parallelepiped shape, the support 34 may be provided at each of the four corners.

Examples of a material of the supports 34 include metals, ceramics, and cermets. Specific examples include Ni and Ni-containing cermets. Examples of the Ni-containing cermets include Ni—YSZ and Ni—BaZr₁₋ₓ₁Ybₓ₁O_{3-δ}. Note that in an instance where the supports 34 are made of a metal, insulation may be provided to prevent shorting between the first electrode 12 and the third electrode 22 from occurring via the supports 34.

### Fifth Embodiment

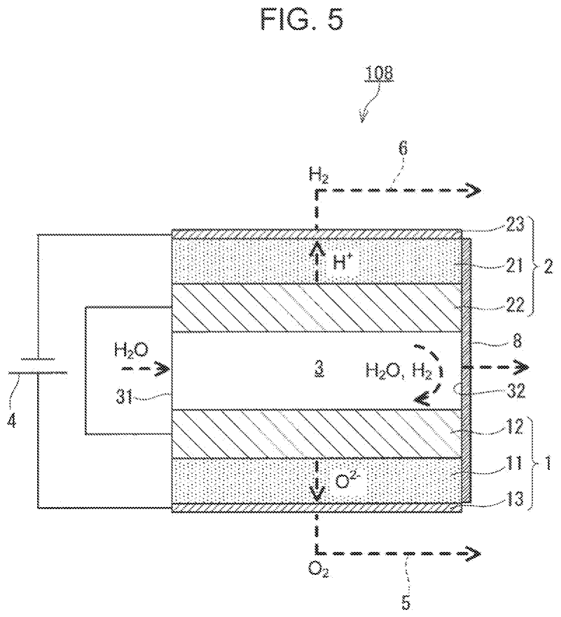

FIG. 5 illustrates a cross section of an electrochemical cell 108, according to a fifth embodiment of the present disclosure. In the electrochemical cell 108, a downstream end of a gas path 3 is closed. In other words, an outlet 32 of the gas path 3 is closed. In the instance where the gas path 3 is closed, the entirety of the supplied water vapor is used for the water vapor electrolysis reaction. That is, water vapor utilization efficiency can be maximized.

The electrochemical cell 108 additionally includes a seal member 8, which is a member for closing the gas path 3. The seal member 8 is provided on a downstream side of the gas path 3 with respect to a water vapor flow direction. The seal member 8 also serves to connect a first cell 1 to a second cell 2. In the present embodiment, the seal member 8 is attached to end surfaces of the first cell 1 and the second cell 2, which are downstream side surfaces with respect to the water vapor flow direction. Accordingly, outflow of the water vapor to the outside of the space (e.g., the gas path 3) between the first cell 1 and the second cell 2 is prevented.

Examples of a material of the seal member 8 include seal materials, such as thermiculite and crystalline glass.

In the present embodiment, the seal member 8 has a plate shape and extends from a side surface of the first electrolyte layer 11 to a side surface of the second electrolyte layer 21 to connect the first cell 1 and the second cell 2 to each other. It should be noted that the structure for closing the downstream end of the gas path 3 is not particularly limited. For example, the seal member 8 may be present exclusively on a region from a side surface of the first electrode 12 to a side surface of the third electrode 22. The first electrode 12 may be connected to the third electrode 22 by the seal member 8.

Furthermore, the seal member 8 may be configured such that the downstream end of the gas path 3, that is, the outlet 32 of the gas path 3 can be opened and closed. For example, the seal member 8 may be provided with a gas discharge mechanism such as an on-off solenoid valve. In the instance where the outlet 32 of the gas path 3 is closed, impurities that do not contribute to the water vapor electrolysis reaction may accumulate in the gas path 3. By controlling the gas discharge mechanism to open the outlet 32 of the gas path 3, thereby removing impurities regularly or at a selected timing, it is possible to continue an efficient water vapor electrolysis reaction and continue efficient hydrogen separation.

### Sixth Embodiment

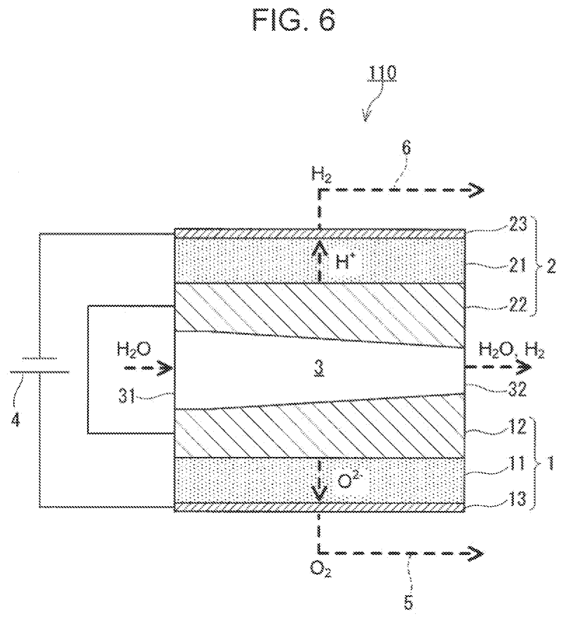

FIG. 6 illustrates a cross section of an electrochemical cell 110, according to a sixth embodiment of the present disclosure. In the electrochemical cell 110, a flow path cross-sectional area of a gas path 3 is larger at an upstream part of the gas path 3 than at a downstream part of the gas path 3. In other words, an open area of an inlet 31 of the gas path 3 is larger than an open area of an outlet 32 of the gas path 3. The flow path cross-sectional area of the gas path 3 continuously decreases in a water vapor flow direction. In other words, a distance between the first electrode 12 and the third electrode 22 continuously decreases in the water vapor flow direction. This configuration facilitates one-direction flow of the water vapor used in the reaction, from an upstream side toward a downstream side. This enables the water vapor electrolysis reaction to proceed efficiently.

In the present embodiment, the above-described configuration is realized by configuring a thickness of at least one of the first electrode 12 or the third electrode 22 such that the thickness continuously increases from the upstream side of the gas path 3 toward the downstream side thereof. Note that even in instances where the flow path cross-sectional area of the gas path 3 decreases in a stepwise manner, the same effect can be produced, depending on a shape of the gas path 3.

The “open area of the inlet 31 of the gas path 3” refers to the flow path cross-sectional area of the gas path 3 at a position of an upstream end of a first cell 1 and a second cell 2. The “open area of the outlet 32 of the gas path 3” refers to the flow path cross-sectional area of the gas path 3 at a position of a downstream end of the first cell 1 and the second cell 2. The “position of an upstream end” refers to a position of the upstream end with respect to the water vapor flow direction. The “position of a downstream end” refers to a position of the downstream end with respect to the water vapor flow direction. Note that, in FIG. 6, the thickness of the first electrode 12 is varied, and the thickness of the third electrode 22 is varied. However, the thicknesses may not necessarily be varied. In other words, the thickness of the first electrode 12 may be uniform, and the thickness of the third electrode 22 may be uniform. For example, the first cell 1 and the second cell 2 may be positioned not parallel to each other but oblique to each other. In instances where such a configuration is employed, the open area of the inlet 31 of the gas path 3 is larger than the open area of the outlet 32 of the gas path 3 in the electrochemical cell 110.

### Seventh Embodiment

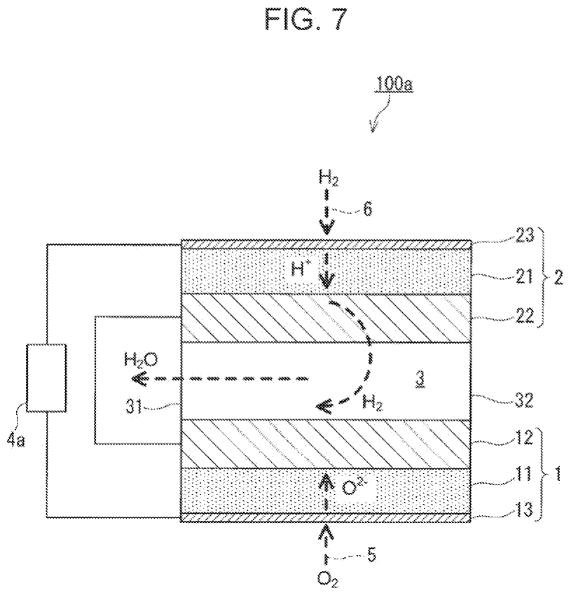

FIG. 7 illustrates a cross section of an electrochemical cell 100a, according to a seventh embodiment of the present disclosure. The electrochemical cell 100a has the same configuration as the configuration of the electrochemical cell 100, which has been described with reference to FIG. 1, except that an external load 4a replaces the power source 4. The configurations of a first cell 1 and a second cell 2 are as described above in the first embodiment.

The reaction that proceeds at each of the electrodes of the electrochemical cell 100a is a reaction in the reverse direction to that of the reaction that proceeds at each of the electrodes of the electrochemical cell 100 of the first embodiment. In the present embodiment, a power generation reaction is carried out in the first cell 1 by using oxygen supplied from the outside and hydrogen that has passed through the second cell 2. The present embodiment enables the supply of electrical energy to the outside. The present embodiment is different from the first embodiment in this regard.

Operation of the electrochemical cell 100a will be described in detail.

An operating temperature of the first cell 1 and the second cell 2 is, for example, greater than or equal to 500° C. and less than or equal to 1000° C. Thus, the same operating temperature may be used in the present embodiment and the first embodiment.

First, hydrogen is supplied to a fourth electrode 23 of the second cell 2. At the fourth electrode 23, an oxidation reaction of the hydrogen occurs, which generates protons. Specifically, the hydrogen is oxidized and converted to protons at or near an interface between a second electrolyte layer 21 and the fourth electrode 23. The protons migrate through the second electrolyte layer 21 to reach a third electrode 22. At the third electrode 22, a reduction reaction of the protons occurs, which generates hydrogen. Specifically, the protons are reduced and converted to hydrogen at or near an interface between the second electrolyte layer 21 and the third electrode 22. The hydrogen generated at a surface of the second cell 2 diffuses through the gas path 3 to reach a surface of the first cell 1.

The first cell 1 generates power by using the hydrogen supplied to the first electrode 12 and the oxygen supplied to a second electrode 13. Specifically, a gas containing oxygen is supplied to the second electrode 13 of the first cell 1. A typical example of the gas containing oxygen is air, At the second electrode 13, a reduction reaction of the oxygen occurs, which generates oxide ions. The oxide ions migrate through the first electrolyte layer 11 to reach the first electrode 12 At the first electrode 12, an electrochemical reaction that generates water vapor and electrons from the oxide ions and hydrogen proceeds. The water vapor and unreacted hydrogen are directed to the outside of the electrochemical cell 100a through the gas path 3. The hydrogen may be combusted by using a burner or by catalytic combustion.

The reaction at each of the electrodes is as follows.

First electrode 12: 2H₂+2O²⁻→2H₂O+4e⁻

Second electrode 13: O₂+4e⁻→2O²⁻

Third electrode 22: 2H⁺+2e⁻→H₂

Fourth electrode 23: H₂→2H⁺+2e⁻

The present embodiment enables pure hydrogen to be generated in the second cell 2 and supplied to the first cell 1 even in instances in which the gas to be supplied to the fourth electrode 23 of the second cell 2 contains not only hydrogen but also impurities, such as water vapor or carbon dioxide. As a result, the following effects, for instance, are produced in the first cell 1: improvement in power generation performance and inhibition of carbon deposition. The gas to be supplied to the second cell 2 may be, for example, a hydrogen-containing gas obtained by reforming a raw gas, such as methane, or a hydrogen-containing gas obtained by performing water vapor electrolysis.

The reaction that proceeds in the first cell 1 is an electrochemical reaction that generates water vapor and electrical energy from hydrogen and oxygen (i.e., a reaction in a fuel cell). The electrical energy may be supplied to the external load 4a, which is connected to the first cell 1. A part of the electrical energy is used as energy for the proton conduction that takes place in the second cell 2. The electrochemical cell 100a serves as a fuel cell and generates electrical energy.

The present embodiment enables pure hydrogen to be generated in the second cell 2 and supplied to the first cell 1 even in instances in which the gas to be introduced into a third passage 5 contains not only hydrogen but also impurities, such as water vapor or carbon dioxide. As a result, the following effects, for instance, are produced in the first cell 1: improvement in power generation performance and inhibition of carbon deposition.

Electrochemical cells according to the present disclosure are suitable for a hydrogen generation system or a fuel cell system. The electrochemical cells according to the present disclosure may also be utilized in a hydrogen purification apparatus or an electrochemical hydrogen pump, such as a hydrogen compressor.

What is claimed is:

1. An electrochemical cell comprising:
a first cell including a first electrolyte layer containing an oxide ion conductor; and
a second cell including a second electrolyte layer containing a proton conductor, the second cell being disposed to face the first cell.

2. The electrochemical cell according to claim 1, further comprising a gas path provided between the first cell and the second cell, wherein
the first cell and the second cell face each other across the gas path.

3. The electrochemical cell according to claim 2, wherein a downstream end of the gas path is dosed.

4. The electrochemical cell according to claim 2, further comprising a porous layer disposed between the first cell and the second cell, wherein
at least a part of the gas path is composed of the porous layer,

5. The electrochemical cell according to claim 2, further comprising a support disposed in the gas path and the support is in contact with the first cell and the second cell,

6. The electrochemical cell according to claim 2, wherein a flow path cross-sectional area of an upstream part of the gas path is larger than a flow path cross-sectional area of a downstream part of the gas path.

1. electrochemical cell according to claim 1, wherein
the first cell further includes a first electrode and a second electrode,
in the first cell, the first electrolyte layer is disposed between the first electrode and the second electrode,
the second cell further includes a third electrode and a fourth electrode,
in the second cell, the second electrolyte layer is disposed between the third electrode and the fourth electrode, and
the first electrode and the third electrode face each other.

8. The electrochemical cell according to claim 7, wherein
hydrogen is generated at the first electrode,
hydrogen is generated at the second electrode,
hydrogen is converted to protons at the third electrode, and
hydrogen is generated at the fourth electrode.

9. The electrochemical cell according to claim 1, further comprising a power source that supplies power to the first cell and the second cell.

10. The electrochemical cell according claim 1, further comprising:
a first power source that supplies power to the first cell; and
a second power source that supplies power to the second cell.

11. The electrochemical cell according to claim 1, wherein the proton conductor includes at least one selected from the group consisting of BaZr₁₋ₓ₁M1ₓ₁O_{3-δ}, BaCe₁₋ₓ₂M2ₓ₂O_{3-δ}, and BaZr_{1-x3-y3}Ceₓ₃M3_{y3}O_{3-δ}, where
M1, M2, and M3 each include at least one selected from the group consisting of Pr, Nd, Pm, Sm, Eu, Gd, Tb, Dy, Ho, Er, Tm, Yb, Y, Sc, In, and Lu,
a value of x1 satisfies 0<x1<1,
a value of x2 satisfies 0<x2<
a value of x3 satisfies 0<x3<1,
a value of y3 satisfies 0<y3<1, and
a value of δ satisfies 0<δ<0.5.

12. The electrochemical cell according to claim 11, wherein the proton conductor is made of BaZr₁₋ₓ₁M1ₓ₁O_{3-δ}.

13. The electrochemical cell according to claim 7, wherein
hydrogen is converted to protons at the fourth electrode,
hydrogen is generated at the third electrode, and
the first cell generates power by using hydrogen supplied to the first electrode and oxygen supplied to the second electrode,

14. A hydrogen generation method comprising:
disposing a first cell and a second cell so as to face each other, the first cell including an oxide on conductor as an electrolyte, the second cell including a proton conductor as an electrolyte;
generating hydrogen and oxygen by decomposing water vapor by using the first cell; and
separating the hydrogen from a mixture gas of the hydrogen generated in the first cell and water vapor which has not been decomposed in the first cell.
